(19) United States
(12) Patent Application Publication
(10) Pub. No.: US 2024/0103297 A1
(43) Pub. Date: Mar. 28, 2024

(54) Ophthalmic Lenses and Methods for Correcting, Slowing, Reducing, and/or Controlling the Progression of Myopia

(71) Applicant: Brien Holden Vision Institute Limited, Sydney, New South Wales (AU)

(72) Inventors: Padmaja Sankaridurg, Marouba, New South Wales (AU); Hassan Esfandiarijahromi, Campsie, New South Wales (AU); Arthur Back, Danville, CA (US)

(21) Appl. No.: 17/769,190

(22) PCT Filed: Oct. 14, 2020
(86) PCT No.: PCT/IB2020/059644

§ 371 Date: Apr. 14, 2022

Related U.S. Application Data
(60) Provisional application No. 62/915,404, filed on Oct. 15, 2019.

(51) Int. Cl. G02C 7/02; G02C 7/04

(52) U.S. Cl. CPC G02C 7/022; G02C 7/024; G02C 7/04; G02C 2202/24

(57) ABSTRACT

An ophthalmic lens comprising a power profile that incorporates a plurality of lens powers wherein some of the lens powers are designed to correct for distance refractive error of the eye and other powers are either approximately relatively positive or approximately relatively negative to the distance refractive error power or both and the ophthalmic lens is designed to provide a through focus retinal image quality curve with the peak positioned in front of the retinal image plane for all pupils of about 4 to 6 mms in diameter on a model eye with zero aberrations. The through focus retinal image quality peak being similarly positioned with respect to the pupils in said range.

### CROSS-REFERENCE TO RELATED APPLICATIONS

This application claims priority to U.S. Provisional Application No. 62/915,404, filed on Oct. 15, 2019. This application is related to International Application No. PCT/AU2013/000354, filed on Apr. 5, 2013 and published as WO 2013/149303 and to International Application No. PCT/AU2013/001137, filed on Oct. 4, 2013 and published as WO 2014/059465. These priority and related applications are herein incorporated by reference in their entirety.

### TECHNICAL FIELD

This disclosure relates to ophthalmic lenses and more particularly, to ophthalmic lenses and methods for correcting, slowing, reducing, and/or controlling the progression of myopia.

### BACKGROUND

The discussion of the background in this disclosure is included to explain the context of the disclosed embodiments. This is not to be taken as an admission that the material referred to was published, known or part of the common general knowledge at the priority date of the embodiments and claims presented in this disclosure.

Myopia, commonly referred to as shortsightedness, is a disorder of the eye that results in distant objects focused in front of the retina. Accordingly, the image on the retina is not in focus and therefore, the image of the object is blurred. Optical correction strategies for myopia have employed using ophthalmic lenses to shift the image plane to the retina and provide clear vision. However, these strategies may not slow eye growth and therefore myopia continues to progress. More recently, a number of optical strategies were developed to slow the progression of myopia and these commonly employ myopic defocus at the central and/or peripheral retina, whilst attempting to simultaneously provide acceptable vision at the retina. These strategies, when incorporated in contact lens and spectacle lenses, may slow the progression of myopia to a certain extent.

Although optical strategies may slow the progression of myopia, the efficacy of such strategies may vary between individuals. Amongst other factors, the variation in efficacy between individuals for a particular ophthalmic lens design may be dependent on the pupil size of the individual. There is significant variation in pupil sizes between individuals. Furthermore, even for a given individual, there is a significant variation in pupil diameter in response to factors such as fixation distance, cognitive demand and luminance. Indeed with certain myopia control strategies such as Orthokeratology, a greater myopia control efficacy may be observed with larger than smaller pupils whereas no such difference in myopia progression may be observed with single vision contact lenses (Chen et al, Optom vis Sci, 89(11), 1636, 2012). This may be because in an eye with a larger pupil and wearing an orthokeratology lens, more of the peripheral retina may be exposed to myopic defocus compared to an eye with a smaller pupil and using an orthokeratology lens. Therefore, variation in pupil diameter may result in variation in the exposure to myopic defocus at the retinal plane. Additionally, lens designs especially contact lenses are designed for a certain pupil size and therefore a variation in the pupil size can affect (sometimes significantly) the retinal image quality and therefore the myopia control efficacy of the lens.

Accordingly, there is a need to provide an ophthalmic lens to slow the progression of myopia with a power profile that places the peak of the image in myopic defocus whilst providing acceptable vision and also provides a through focus modulation transfer function that is similar across various pupil diameters. The present disclosure is directed to solving these and other problems disclosed herein. The present disclosure is also directed to pointing out one or more advantages to using exemplary ophthalmic lenses and methods described herein.

### SUMMARY

The present disclosure is directed to overcoming and/or ameliorating one or more of the problems described herein.

The present disclosure is directed, at least in part, to ophthalmic lenses and/or methods for correcting, slowing, reducing, and/or controlling the progression of myopia.

The present disclosure is directed, at least in part, to ophthalmic lenses and/or methods with a power profile that results in a through focus retinal image quality curve on a model eye with zero aberrations and provides for distance viewing, a through focus retinal image quality (TFRIQ) curve with the peak of the curve positioned in front of the retinal image plane, i.e. in myopic defocus for all (or substantially all) pupil diameters ranging from about approximately 4 to 6 mms (e.g., about 4, 4.5, 5, 5.5, and/or 6 mm).

The present disclosure is directed, at least in part, to ophthalmic lenses and/or methods that provide, for distance viewing, a through focus retinal image quality (TFRIQ) curve with the peak of the curve positioned, e.g., slightly or substantially in front of the retinal image plane in myopic defocus for all (or substantially all) pupil diameters ranging from about approximately 4 to 6 mms (e.g., about 4, 4.5, 5, 5.5, and/or 6 mm) on a model eye with zero aberrations.

The present disclosure is directed, at least in part, to ophthalmic lenses and/or methods that provide, for distance viewing, a through focus retinal image quality curve with the peak of the curve positioned in front of the retinal image plane by about +0.3D to +0.75D (i.e. in myopic defocus) (e.g., by any combination of one or more of about +0.3, +0.35, +0.4, +0.45, +0.5, +0.55, +0.6, +0.65, +0.7, and +0.75) for all (or substantially all) pupil diameters ranging from about approximately 4 to 6 mms (e.g., about 4, 4.5, 5, 5.5, and/or 6 mm) on a model eye with zero aberrations.

The present disclosure is directed, at least in part, to ophthalmic lenses and/or methods that provide, for distance viewing, a through focus retinal image quality curve with the peak of the curve positioned in front of the retinal image plane at target vergence of about +0.3D to +0.75D (e.g., by any combination of one or more of about +0.3D, +0.35D, +0.4D, +0.45D, +0.5D, +0.55D, +0.6D, +0.65D, +0.7D, and +0.75D) for all (or substantially all) pupil diameters ranging from about approximately 4 to 6 mms (e.g., about 4, 4.5, 5, 5.5, and/or 6 mm) on a model eye with zero aberrations.

The present disclosure is directed, at least in part, to an ophthalmic lens (e.g., a contact lens) with a power profile that incorporates a plurality of lens powers to provide a through focus retinal image quality curve with the peak of the curve positioned in front of the retinal image plane at about +0.3 to +0.75D (i.e. in myopic defocus) (e.g., by any combination of one or more of about 0.3D, +0.35D, +0.4D, +0.45D, +0.5D, +0.55D, +0.6D, +0.65D, +0.7D, and +0.75D) for all (or substantially all) pupils of about 4 to 6 mms (e.g., about 4, 4.5, 5, 5.5, and/or 6 mm) in diameter on a model eye with zero aberrations.

The present disclosure is directed, at least in part, to an ophthalmic lens (e.g., a contact lens) with a power profile that incorporates a plurality of lens powers wherein some of the lens powers are designed to correct for distance refractive error of the eye and other powers (e.g., some or all of the other powers) are either approximately relatively positive or approximately relatively negative to the distance refractive error power or both and the ophthalmic lens is designed to provide a through focus retinal image quality the peak of the curve positioned in front of the retinal image plane at about +0.3 to about +0.75D (i.e. in myopic defocus) (e.g., by any combination of one or more of about 0.3D, +0.35D, +0.4D, +0.45D, +0.5D, +0.55D, +0.6D, +0.65D, +0.7D, and +0.75D) for all pupils of about 4 to 6 mms (e.g., about 4, 4.5, 5, 5.5, and/or 6 mm) in diameter on a model eye with zero aberrations.

The present disclosure is directed, at least in part, to an ophthalmic lens (e.g., a contact lens) with a power profile that incorporates a plurality of lens powers wherein some of the lens powers are designed to correct for distance refractive error of the eye and other powers (e.g., some or all of the other powers) are approximately relatively positive to the distance refractive error power and the ophthalmic lens is designed to provide a through focus retinal image quality curve with the peak of the curve positioned in front of the retinal image plane at about +0.3 to about +0.75D (i.e. in myopic defocus) (e.g., by any combination of one or more of about 0.3D, +0.35D, +0.4D, +0.45D, +0.5D, +0.55D, +0.6D, +0.65D, +0.7D, and +0.75D) for all pupils of about 4 to 6 mms (e.g., about 4, 4.5, 5, 5.5, and/or 6 mm) in diameter on a model eye with zero aberrations.

The present disclosure is directed, at least in part, to an ophthalmic lens (e.g., a contact lens) with a power profile that incorporates a plurality of lens powers wherein some of the lens powers are designed to correct for distance refractive error of the eye and other powers (e.g., some or all of the other powers) are either approximately relatively positive to the distance refractive error power or approximately relatively negative to the distance refractive error and the lens is designed to provide a through focus retinal image quality curve with the peak of the curve displaced in front of the retinal image plane at about +0.3 to +0.75D (i.e. in myopic defocus)) (e.g., by any combination of one or more of about 0.3D, +0.35D, +0.4D, +0.45D, +0.5D, +0.55D, +0.6D, +0.65D, +0.7D, and +0.75D) for all pupils of about 4 to 6 mms (e.g., about 4, 4.5, 5, 5.5, and/or 6 mm) in diameter on a model eye with zero aberrations and the lens provides good vision at all (or substantially all) distances irrespective of the pupil size (e.g., irrespective of pupil sizes in the range of about 4-6 mm).

Other features and advantages of the subject matter described herein will be apparent from the description and drawings, and from the claims.

### BRIEF DESCRIPTION OF THE DRAWINGS

Aspects of the embodiments described herein may be understood from the following detailed description when read with the accompanying figures.

FIG. 1 is a schematic plot of pupil diameter as a function of age and illuminance cd m⁻² and illustrating the variance of pupil size by age and amount of illuminance.

FIG. 2 is an illustration of the power profile of a center distance design contact lens used to slow progression of myopia and the through focus retinal image quality (TFRIQ) for pupil diameters from 3 to 6 mm on a model eye with zero aberration.

FIG. 3 is an illustration of the power profile of a center near design contact lens used to slow progression of myopia and the through focus retinal image quality (TFRIQ) for pupil diameters from 3 to 6 mm on a model eye with zero aberration

FIG. 4 is an illustration of the power profile of a lens with higher order aberrations used to slow progression of myopia and the through focus retinal image quality (TFRIQ) for pupil diameters ranging from 3 to 6 mm on a model eye with zero aberration.

FIG. 5 illustrates the power profile and the resultant through focus retinal image quality (TFRIQ) of an exemplary ophthalmic lens for a myopic eye in accordance with certain embodiments described herein (Example 1).

FIG. 6 illustrates the power profile and the resultant through focus retinal image quality (TFRIQ) of an exemplary ophthalmic lens for a myopic eye in accordance with certain embodiments described herein (Example 2).

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The subject headings used in the detailed description are included for the ease of reference of the reader and should not be used to limit the subject matter found throughout the disclosure or the claims. The subject headings should not be used in construing the scope of the claims or the claim limitations.

The term “about” as used in this disclosure is to be understood to be interchangeable with the term approximate or approximately.

The term “comprise” and its derivatives (e.g., comprises, comprising) as used in this disclosure is to be taken to be inclusive of features to which it refers, and is not meant to exclude the presence of additional features unless otherwise stated or implied.

The term “myopia” or “myopic” as used in this disclosure is intended to refer to an eye that is already myopic, is pre myopic, or has a refractive condition that is progressing towards myopia.

The term “stop signal” as used in this disclosure refers to an optical signal that may facilitate slowing, arresting, retarding, inhibiting, or controlling the growth of an eye and/or refractive condition of the eye.

The term “ophthalmic lens” as used in this disclosure is intended to include one or more of a spectacle lens or a contact lens.

The term “through focus through focus retinal image quality (TFRIQ)” (or “through focus RIQ or “RIQ”) as used in this disclosure refers to visual performance or the retinal image quality (RIQ) of the system and is a ratio of the peak value of an aberrated point spread function to an equivalent value in a diffraction limited point spread function and is measured on a scale of 1 to 0 wherein, the lower the RIQ, the poorer the optical performance. The through focus RIQ was determined for spatial frequencies ranging from about 0 cycles/degree to about 30 cycles/degree for wavelengths from about 550 nm to about 600 nms.

The term “model eye” as used in this disclosure refers to a Navarro-Escudero eye modified to mimic presbyopic eyes with no accommodation and the ray-tracing routines performed in a ray tracing program (i.e., ZEMAX, FOCUS software) with the aberration terms set to zero.

The term “multifocal” as used in this disclosure refers to an ophthalmic lens that has a plurality of focal lengths and/or powers.

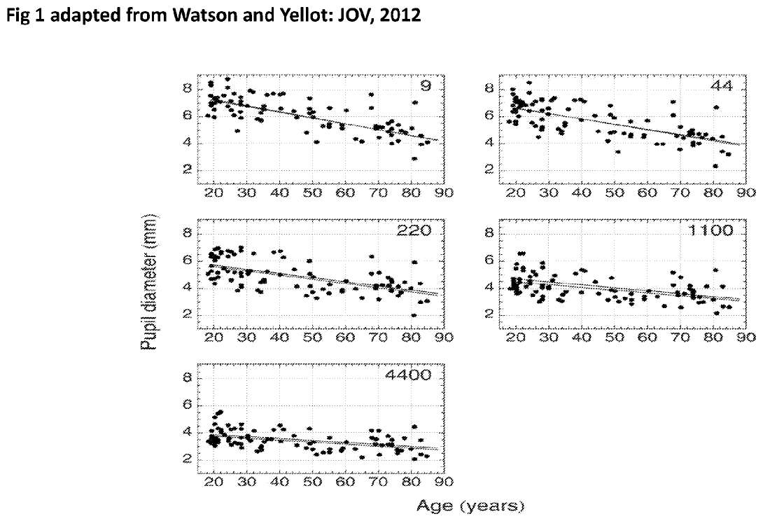

FIG. 1 illustrates a schematic plot of pupil diameter as adapted from Watson and Ellot, 2012 (Journal of Vision September 2012, Vol. 12, 12. doi: 10.1167/12.10.12) for 91 subjects ranging in age from 17 to 83 years as a function of age and luminance (i.e., 9, 44, 220, 1100 and 4400 cd m⁻²). As illustrated, in young adults, with the exception of very high light levels (4400 cd/m²), the pupil size is commonly 4 mms and larger. Considering for example the graph at 220 cd/m² at a given age, there is considerable variation in the pupil size between individuals—pupil size varies in size from approximately 3 mms or more. For example at age 20, the pupil size in the graph varies from approximately 4 mms to about approximately 7 mms. Furthermore, as the figure illustrates, pupil size decreases as a function of age and as a function of increasing luminance. This suggests that for a given individual, the background illuminance can affect the pupil diameter. Myopia control contact lenses generally incorporate distinct areas or zones of relatively positive power (e.g., concentric type lenses with clear center distance or center near type bifocals) or may include higher order aberrations such as spherical aberration to increase the depth of focus and create multifocality. The relatively positive powered areas or the incorporation of higher order aberrations such as spherical aberration may be designed to result in myopic defocus at the retina with the image focused in front of the retina. Although the ophthalmic lenses are designed to induce myopic defocus (e.g., clear image peak in front of the retina whilst viewing distant objects), variation in pupil size may cause the image peak to shift to a position substantially further in front of the retina, substantially closer to the retina and/or behind the retina. Furthermore, by expanding the pupil size to larger diameters, there may be other effects such as a decrease or variation in the retinal image quality.

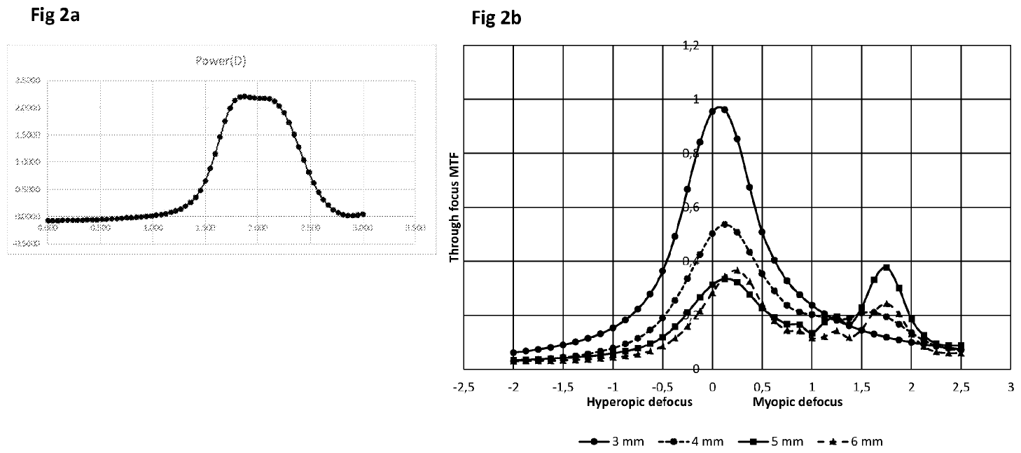

This shift in retinal image curve and its peak may be evaluated using TFRIQ curve across various pupil sizes. In FIG. 2, this is illustrated using the example of a center distance contact lens with a concentric ring of plus power. FIG. 2a is a schematic of a center distance contact lens used to slow the progression of myopia. The lens has a power profile with concentric rings of positive power of +2.00D. As illustrated in FIG. 2a, across a radius of 3 mms (or a diameter of 6 mms), the lens has a central zone (approximately 1.1 mm in radius) that is directed to correct for the distance refractive error of the eye followed by a ring of relatively positive power of approximately +2.00D (center distance contact lens). FIG. 2b demonstrates the TFRIQ with the lens for a model eye with zero aberration for pupil diameters ranging in size from 3 to 6 mm in 1 mm steps. In FIG. 2b, the TFRIQ curve to the right of the retinal image plane refers to target vergence that is positive, i.e. in myopic defocus relative to the retinal image plane. The TFRIQ curve to the left of the retinal image plane refers to target vergence that is negative, i.e. in hyperopic defocus relative to the retinal image plane. As observed from the graph, at a pupil size of 3 mm, the peak on the TFRIQ curve was close to the retinal plane (vergence of 0.125D, RIQ 0.96). As illustrated, the small pupils produce higher image quality. However, such pupil sizes are uncommon especially in young children. As the pupil size increases, e.g., at 4 mm, the retinal image quality is reduced with the peak of the TFRIQ curve displaced at vergence of +0.125D (i.e. in myopic defocus and RIQ 0.536). For a pupil size of 5 mms, the TFRIQ curve is bimodal with two distinct peaks with the highest RIQ peak at 1.75D (RIQ 0.38) followed by a second peak at 0.125D vergence (RIQ 0.34). This competing defocus may result in subjective symptoms of ghosting and double vision and reduced vision performance. The peak closer to the retinal image plane corresponds to the central zone whereas the peak at 1.75D vergence (myopic defocus) corresponds to the relatively positive power. Similarly, at 6 mms, the TFRIQ curve is bimodal with the two peaks with the highest RIQ peak positioned at vergence of 0.25D (RIQ 0.36) followed by a second peak at 1.75D vergence (myopic defocus, RIQ 0.24). As observed, there may be a significant shift in the image peaks across the various pupil sizes resulting in varying image quality at the retina for varying pupil sizes and may result in inadequate myopia control efficacy for certain individuals

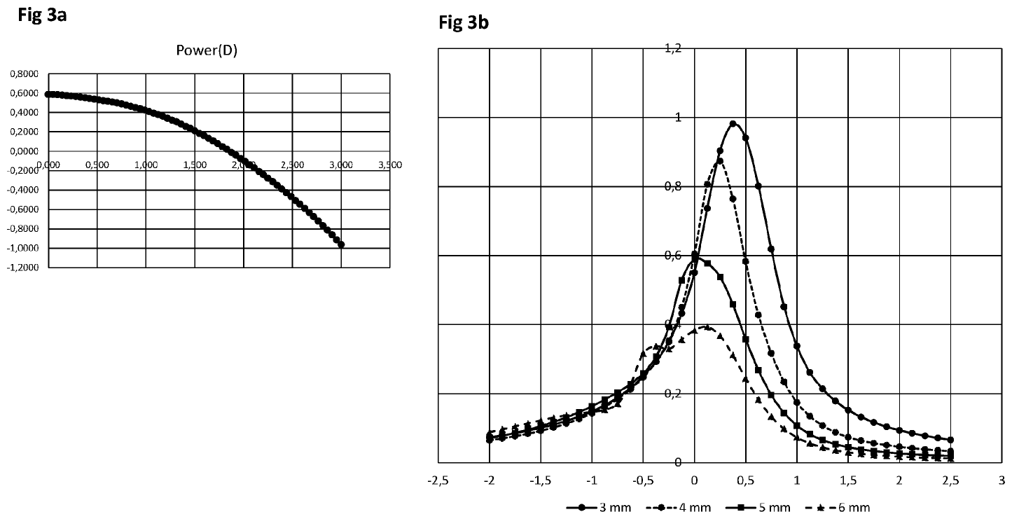

FIG. 3a is a schematic of a center near contact lens used to slow the progression of myopia. As illustrated in FIG. 3a, the lens has a positive power of approximately +0.60 at the center of the lens with a progressive decrease in positive power away from the center of the lens. FIG. 3b demonstrates the through focus RIQ with the lens for a model eye with zero aberration for pupil diameters ranging in size from 3 to 6 mm in 1 mm steps. In FIG. 3b, the TFRIQ curve to the right of the retinal image plane refers to target vergence that is positive, i.e., in myopic defocus relative to the retinal image plane. The TFRIQ curve to the left of the retinal image plane refers to target vergence that is negative, i.e. in hyperopic defocus relative to the retinal image plane. For a pupil size of 3 mm, the TFRIQ is high but the peak of the curve is positioned in front of the retinal image plane at vergence of 0.375D (myopic defocus, RIQ 0.98). With a larger pupil size of 4 mm, the peak of the through focus RIQ shifts towards the retinal image plane, i.e. less myopic defocus compared to 3 mms (vergence of 0.25, RIQ 0.87). With an increasing pupil size, e.g., at 5 mms and 6 mms it is seen that the peak of the RIQ curve shifts further towards the retinal plane (0.125D) and (RIQ 0.58 and 0.39 mm). Furthermore, at 6 mms, there is a significant shift towards the hyperopic direction. Therefore, a lens as illustrated in FIG. 3 may not provide sufficient myopic defocus especially with larger pupil sizes and there may be a significant shift in the TFRIQ peaks across the various pupil sizes resulting in varying image quality at the retina for varying pupil sizes.

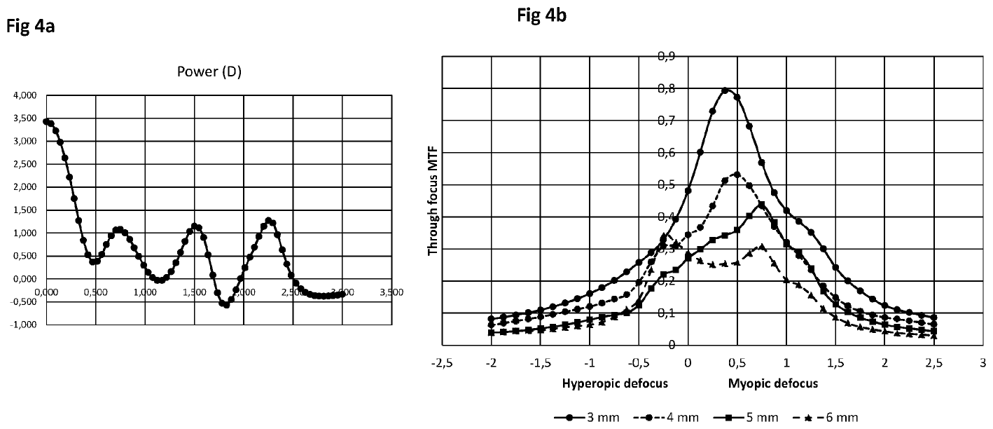

FIG. 4a is a schematic of an extended depth of focus contact lens with a plurality of lens powers and used to slow the progression of myopia. FIG. 4b demonstrates the through focus RIQ with the lens for a model eye with zero aberration for pupil diameters ranging in size from 3 to 6 mm in 1 mm steps. In FIG. 4b, the TFRIQ curve to the right of the retinal image plane refers to target vergence that is positive, i.e. in myopic defocus relative to the retinal image plane. The TFRIQ curve to the left of the retinal image plane refers to target vergence that is negative, i.e. in hyperopic defocus relative to the retinal image plane. As with the previous examples, for a pupil size of 3 mm the peak of the RIQ is high but positioned in front of the retinal image plane creating myopic defocus (0.375D vergence, RIQ 0.79). With an increase in pupil diameter to about 4 mm, the peak of the through focus RIQ shifts further away from the retinal image plane, i.e. increased myopic defocus compared to 3 mm (0.5D vergence, RIQ 0.53). With a further increase in pupil size, e.g., at 5 mms it is seen that the peak of the RIQ shifts further away from the retinal plane (0.75D vergence, RIQ 0.43 mm). Furthermore, at 6 mms, the TFRIQ curve is bimodal with 2 peaks with the highest peak in hyperopic defocus (−0.25 vergence, RIQ 0.34) and a second peak in myopic defocus (0.75D vergence, RIQ 0.31). Thus especially at larger pupils, there may be a decrease in retinal image quality and may result in inadequate myopia control efficacy for certain eyes.

Accordingly, it may be desirable to have an improved ophthalmic lens design that results in the shape of the through focus RIQ curve being substantially similar for various pupil diameters (e.g., pupil diameters that are normally encountered during the course of the day and/or between individuals, especially children with myopia). As discussed above with respect to FIG. 1, the pupil diameters commonly vary from about approximately 4 mms to about approximately 6 mms (e.g., about 4, 4.5, 5, 5.5, and/or 6 mm). In some embodiments, the ophthalmic lens design may result in the image peaks positioned in front of the retina (in myopic defocus) and being substantially similar for pupil diameters ranging in size from about approximately 4 mms to about approximately 6 mms (e.g., about 4, 4.5, 5, 5.5, and/or 6 mm). In some embodiments, the ophthalmic lens design may result in the TFRIQ curve peaks positioned in front of the retina, (e.g., in myopic defocus or vergence of about 0.3D to about 1D (e.g., by any combination of one or more of about +0.3D, +0.35D, +0.4D, +0.45D, +0.5D, +0.55D, +0.6D, +0.65D, +0.7D, +0.75D, +0.8D, +0.85D, +0.9D, +0.95D, and +1D) and being substantially similar for pupil diameters ranging in size from about approximately 4 mms to about approximately 6 mms (e.g., about 4, 4.5, 5, 5.5, and/or 6 mm).

In some embodiments, the ophthalmic lens may result in TFRIQ peaks positioned in front of the retina, e.g., in myopic defocus with the peak of the through focus RIQ at 0.4 or above (e.g., above 0.3, 0.35, 0.4, 0.45, or 0.5) across the various pupil sizes (e.g., about 4, 4.5, 5, 5.5, and/or 6 mm). In certain embodiments, the peak of the through focus RIQ curve across all of the pupil diameters between 4 and 6 mms may be 0.4 or higher. In other embodiments, the peak of the through focus RIQ curve for most of the pupil diameters between 4 and 6 mms may be 0.4 or higher.

In some embodiments, the peak of the through focus RIQ is displaced in myopic defocus of approximately 1D or lower for all pupil diameters ranging from about approximately 4 mm to approximately 6 mms. In some embodiments, for pupil diameters ranging from 4 to 6 mms, the peak of the TFRIQ may be positioned between approximately 0.1 to 1.0D vergence and in myopic defocus, approximately 0.2 to 1.0D vergence and in myopic defocus, approximately 0.3 to 1.0D vergence and in myopic defocus, approximately 0.4 to 1.0D vergence and in myopic defocus, approximately 0.5 to 1.0D vergence and in myopic defocus, approximately 0.6 to 1.0D vergence and in myopic defocus, approximately 0.7 to 1.0D vergence and in myopic defocus, approximately 0.8 to 1.0D vergence and in myopic defocus, by approximately 0.3D or more, by approximately 0.4D or more, by approximately 0.5 D or more.

In some embodiments, the ophthalmic lens design may be achieved by modifying the power profile or the surface profile of the lens by changing the geometry with radii of curvature of the anterior or posterior surface, thickness or a combination of both. In some embodiments, the ophthalmic lens design can be achieved by modifying the refractive index of the lens, incorporation of varying refractive index material or a combination of one or more elements thereof. In some embodiments, the ophthalmic lens design may be achieved by addition or deletion of one or more of the higher order aberrations. In some embodiments, there may be other suitable techniques to create the optical power required to achieve an ophthalmic lens design as described herein.

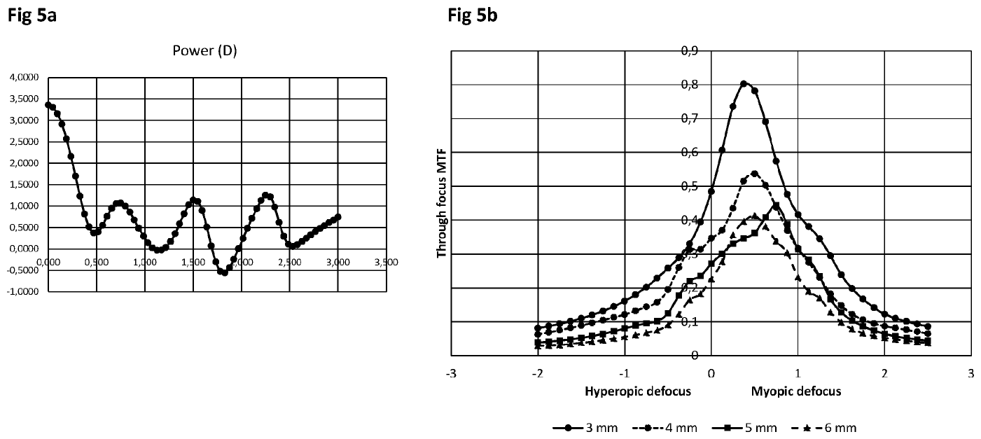

FIG. 5a is an exemplary embodiment of a myopia control lens as described herein. As illustrated in FIG. 5a, the lens has a non-monotonic power profile with the power varying above and below the nominal power profile. FIG. 5b demonstrates the through focus RIQ with the lens for a model eye with zero aberration for pupil diameters ranging in size from 3 to 6 mm in 1 mm steps. In FIG. 5b, the TFRIQ curve to the right of the retinal image plane refers to target vergence that is positive, i.e., in myopic defocus relative to the retinal image plane. The TFRIQ curve to the left of the retinal image plane refers to target vergence that is negative, i.e. in hyperopic defocus relative to the retinal image plane. As can be seen from the graph, the shape of the through focus RIQ is substantially similar and the peak of the TFRIQ curve positioned in myopic defocus, i.e at vergence of about 0.375 to 0.75D for the pupil diameters ranging from 3 to 6 mm with the peak of the RIQ above 0.4 and the lens design was achieved by changing the surface curvature of the front surface of the lens at about from 2.5 mm to 3.0 mms. Furthermore, as illustrated, the differences in peak of the RIQ for pupil sizes between 4 and 6 mms is less than 0.2 and the slope of the through focus RIQ curves are similar. Therefore, irrespective of the pupil size, the lens illustrated in FIG. 5a provides a substantially similar and consistent retinal image quality. In some embodiments, the differences in peak of the RIQ curve for pupil sizes between 4 and 6 mms may be less than about 0.1, 0.15, 0.2, 0.25, 0.3, 0.35, 0.4, 0.45, or 0.5.

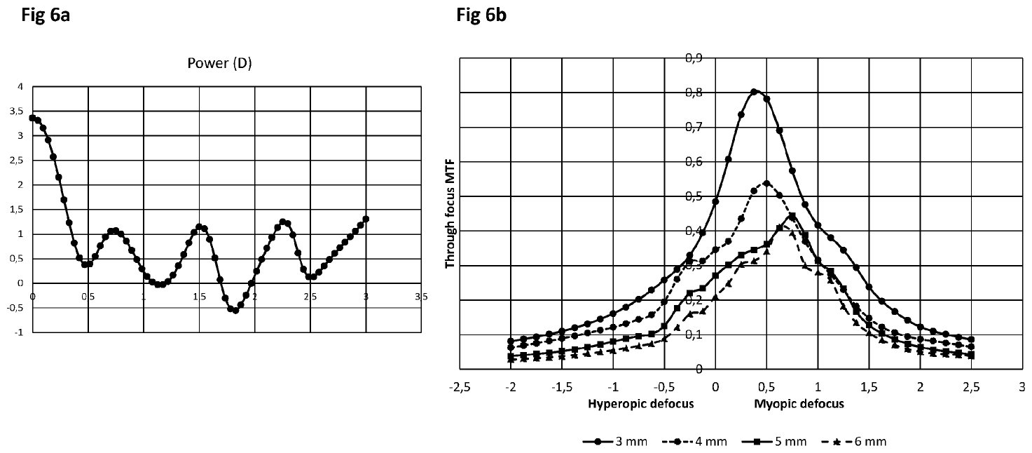

Similarly FIG. 6a is an exemplary embodiment of a myopia control lens. As illustrated in FIG. 6a, the lens has a non-monotonic power profile with the power varying above and below the nominal power profile. FIGS. 6a and 6b show an improvement of the power profile and the through focus RIQ with the lens for a model eye with zero aberration for pupil diameters ranging in size from 3 to 6 mm in 1 mm steps. In FIG. 6b, the TFRIQ curve to the right of the retinal image plane refers to target vergence that is positive, i.e., in myopic defocus relative to the retinal image plane. The TFRIQ curve to the left of the retinal image plane refers to target vergence that is negative, i.e. in hyperopic defocus relative to the retinal image plane. As can be seen from the graph, the peak of the through focus RIQ is positioned in myopic defocus, i.e. at vergence of 0.375 to 0.75D for pupil sizes ranging from 3 to 6 mm with the peak of the retinal image quality above 0.4. Relative to FIG. 4b, FIG. 6B demonstrates the shift in the peak of RIQ at 6 mms to be closer to the slope and peak of the retinal image quality at 5 mms. Thus FIG. 6b also demonstrates an improvement to provide a substantially similar and more consistent retinal image quality.

It will be understood that the embodiments disclosed and defined in this specification extends to all alternative combinations of two or more of the individual features mentioned or evident from the text or drawings. All of these different combinations constitute various alternative aspects of the present disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An ophthalmic lens (e.g., a contact lens) with a power profile that results in a through focus retinal image quality curve on a model eye with zero aberrations, wherein the peak of the through focus retinal image quality curve is positioned in front of the retinal image plane in myopic defocus for all (or substantially all) pupil diameters ranging from about approximately 4 to 6 mms (e.g., about 4, 4.5, 5, 5.5, and/or 6 mm).

2. An ophthalmic lens (e.g., a contact lens) with a power profile that results in a through focus retinal image quality curve on a model eye with zero aberrations, wherein the peak of the through focus retinal image quality curve is positioned in front of the retinal image plane by about +0.3D to +0.75D (e.g., by any combination of one or more of about +0.3, +0.35, +0.4, +0.45, +0.5, +0.55, +0.6, +0.65, +0.7, and +0.75) for all (or substantially all) pupil diameters ranging from about approximately 4 to 6 mms (e.g., about 4, 4.5, 5, 5.5, and/or 6 mm).

3. An ophthalmic lens (e.g., a contact lens) comprising: a power profile that incorporates a plurality of lens powers to provide a through focus retinal image quality curve with the peak positioned in front of the retinal image plane by about +0.3 to +0.75D (e.g., by any combination of one or more of about +0.3, +0.35, +0.4, +0.45, +0.5, +0.55, +0.6, +0.65, +0.7, and +0.75) for all (or substantially all) pupils of about 4 to 6 mms (e.g., about 4, 4.5, 5, 5.5, and/or 6 mm) in diameter on a model eye with zero aberrations.

4-15. (canceled)
